(19) United States
(12) Patent Application Publication
(10) Pub. No.: US 2002/0109003 A1
(43) Pub. Date: Aug. 15, 2002

(54) Welding underwater in a chamber with a flux-type backing

(75) Inventors: Stephen K. Parker, Fremont, CA (US); Ronald M. Horn, Palo Alto, CA (US); Terry L. Chapman, Los Gatos, CA (US); Michael P. Fisher, Dublin, CA (US); Robert W. Whitling, Morgan Hill, CA (US); Jack T. Matsumoto, Sunnyvale, CA (US); Sampath Ranganath, San Jose, CA (US)

Correspondence Address: NIXON & VANDERHYE P.C., 1100 North Glebe Road, 8th Floor, Arlington, VA, 22201-4714, US

(73) Assignee: General Electric Company

(21) Appl. No.: 10/126,879

(22) Filed: Apr. 22, 2002

Related U.S. Application Data
(63) Continuation of application No. 09/679,612, filed on Oct. 5, 2000.

(51) Int. Cl. B23K 1/20; B23K 31/02

(52) U.S. Cl. 228/223

(57) ABSTRACT

Method of welding metal wherein a crack to be welded is surrounded with a flux in a substantially water-free environment and welded. The flux acts as backing for the welding operation and permits the welding to be carried out in the absence of an inert gas purge or metallic backing pre-placed on the weld.

### TECHNICAL FIELD

The present invention relates to welding of metal components in a chamber using a flux-type backing. More particularly, the invention provides a method for welding cracks in nuclear reactor components in a water-free environment using a flux-type backing, without the need for an inert gas back purge or a metallic backing pre-placed on the backside of the weld.

### BACKGROUND OF THE INVENTION

A nuclear reactor contains a core of fissionable fuel which generates heat during fission. The heat is removed from the fuel core by the reactor coolant, i.e., water, which is contained in a reactor pressure vessel. Piping circuits carry the heated water or steam to the steam generators or turbines and carry circulated water or feed water back to the vessel. Operating pressures and temperatures for the reactor pressure vessel are about 7 MPa and 288° C. for a boiling water reactor (BWR), and about 15 MPa and 320° C. for a pressurized water reactor (PWR). The materials employed in both BWRs and PWRs must withstand various loading, environmental and radiation conditions. As used herein, the term “high-temperature water” means water having a temperature of about 150° C. or greater, steam, or the condensate thereof.

Materials exposed to high-temperature water include, for example, carbon steel, alloy steel, stainless steel, and nickel-based, cobalt-based and zirconium-based alloys. Despite careful selection and treatment of these materials for use in water reactors, corrosion occurs on the materials exposed to the high-temperature water. Such corrosion contributes to a variety of problems, e.g., stress corrosion cracking (SCC), crevice corrosion, erosion corrosion, sticking of pressure relief valves and build-up of the gamma radiation-emitting Co-60 isotope.

Stress corrosion cracking (SCC) has been a problem affecting the operational availability of boiling water reactor (BWR) power plants for a number of decades. The problem arises when a combination of sensitized material, tensile stresses, and high-temperature oxygenated water exists during service.

Many of the older reactor plants were inadvertently constructed with higher carbon stainless steel, which was thermally sensitized during fabrication heat treatment or weld joining processes. In addition, the welding practices typically used high heat inputs which were sufficient to lead to tensile residual stresses and the corresponding SCC failures. Repair or replacement of these components is generally very expensive due to the fact that operating plants must be shut down for longer outages to perform major replacements, and due to the high levels of radioactive contamination on the internal surfaces (or activation within the volume) of the plant components.

A number of solutions to the problem of SCC have been proposed over the years, including component material replacement, residual stress reduction, and water chemistry controls (or combinations of these proposals). Another approach is to electric arc weld clad over a previously sensitized region, effectively isolating it from the aggressive water environment. However, this existing method typically does not have universal applicability, since for highly susceptible substrates, existing welding methods can sensitize the edges of the newly clad region. The net effect is to cover an older SCC problem, which only generates the risk of a similar new problem nearby.

An alternative approach is laser fusion of a pre-applied, corrosion-resistant paste over an SCC-susceptible region. However, this process is tedious and highly complex, and expensive when applied remotely to in-vessel components.

Another known process is Gas Tungsten Arc (GTA) fusion of a preplaced sleeve made of corrosion-resistant material. This process however is limited to applications having a geometrically regular surface shape (such as cylindrical) to which the sleeve can be readily preshaped for adequate fit. Many sensitized areas needing to be clad are the heat-affected zones (HAZs) of joining welds, which rarely have regular or smooth surfaces. Other adverse material conditions such as furnace-sensitized, irradiation-sensitized, or cold-worked materials are also in need of a very low heat input corrosion-resistant cladding to prevent SCC.

A need exists for an improved way of welding cracks in nuclear reactor components which avoid the need to shut down the reactor. The present invention seeks to fulfill that need.

### BRIEF SUMMARY OF THE INVENTION

The present inventors have now discovered, surprisingly, that it is possible to conduct welding and repair of metal components in a nuclear reactor using a flux-type backing in a substantially water-free environment. In particular, it has been discovered that it is possible to effect welding of cracks or openings without the presence of an inert gas back-purge or a piece of metallic backing pre-placed on the backside of the weld. Typically, a water-tight enclosure is provided around the outside of the area to be welded to facilitate the generation of a substantially water-free environment within the enclosure, and a “flux-type” or powdered metal material is pre-placed, inserted or injected into the enclosure around the area to be welded to act as a backing material. The flux-type backing material allows welding of the two parts together.

In accordance with one aspect, the invention provides a method of welding, in which a region in a metal component to be welded is surrounded with a flux and the region is welded. The welding is generally carried out in a substantially water-free environment, in which the region to be welded is enclosed in a water-tight enclosure which is filled with flux.

In another aspect, there is provided a method of welding in a component underwater, wherein a region containing a crack to be welded is surrounded with a flux in a substantially water-free environment, and the crack is welded, in the absence of an inert gas purge or metallic backing pre-placed on the weld.

In yet another aspect, there is provided a method of welding in a component in a nuclear reactor, wherein a region containing a crack to be welded is surrounded with a flux in a substantially water-free environment, and the crack is welded.

The invention has the advantage of eliminating the need to machine the region and/or install a backing strip. The placement of an sealed enclosure around the region to be welded allows evacuation of water from the region and introduction of flux-type material to permit welding. This results in considerable savings with respect to time and expense, and can assist in welding of additional areas.

### BRIEF DESCRIPTION OF THE DRAWINGS

The invention will now be described in more detail with reference tot he accompanying drawings, in which:

FIG. 1 illustrates a surface enclosure tool positioned to be attached to a nuclear reactor component with a crack to be welded;

FIG. 2 illustrates the surface enclosure tool in its closed substantially water-tight configuration around the crack to be welded;

FIG. 3 indicates the surface enclosure tool following injection of flux slurry into the enclosure to displace water within the enclosure; and

FIG. 4 illustrates commencement of welding by way of a welding tool situated inside the component.

### DETAILED DESCRIPTION OF THE INVENTION

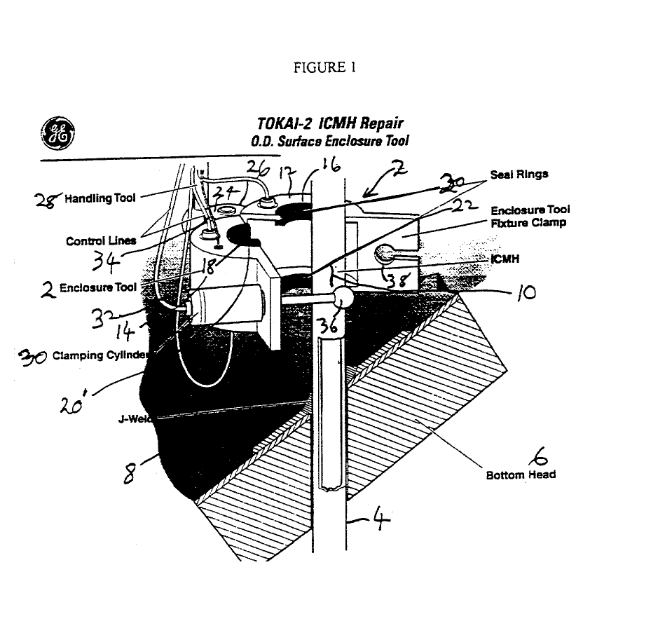

Referring to FIG. 1, there is shown a surface enclosure tool, generally referenced 2, positioned to be attached to a nuclear reactor component 4 extending through bottom head 6 of a nuclear reactor into a water-filled environment 8. The component 4 has a crack 10 requiring welding and repair. In the figures, component 4 is an in-core monitor housing (ICMH), which is a 2″OD pipe extending through the bottom head 6 of the reactor. This is for illustration purposes only, and the invention has wide applicability with respect to the type of component which may be welded. The enclosure tool 2 is comprised of two hinged portions 12, 14 with semicircular regions 16 ,18 carrying split seals (O-rings) 20, 20′, 22, 22′. The portions 12, 14 are connected by a hinge unit 24, having a housing 26 to which is attached a handling tool 28 to facilitate positioning of the tool around the region of the component to be welded by an operator from a remote location outside the reactor. A clamping cylinder 30 is connected to portion 14 of the tool and is actuated by control line 32. A pressure line 34 is provided for admission of air under pressure. The clamping cylinder 30 is provided with a key member 36 which is receivable in a corresponding slot 38 in the other portion 12.

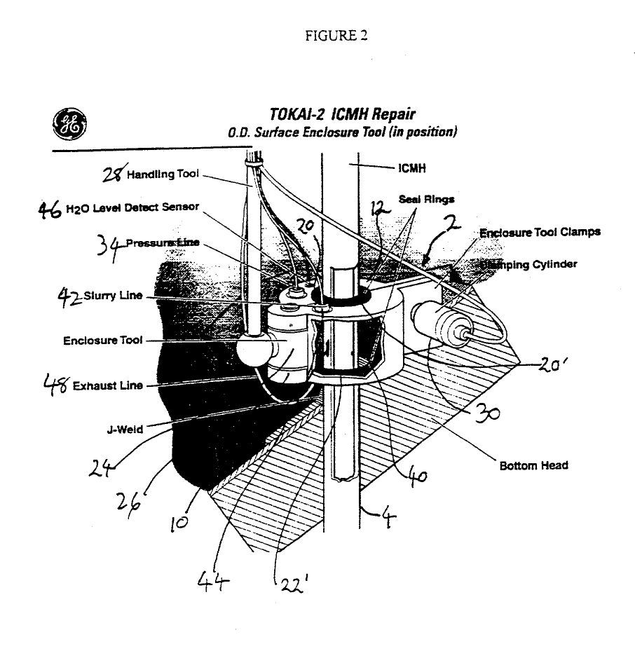

Referring to FIG. 2, the enclosure tool 2 is shown clamped in position about the crack 10 in the component 4 to be welded. The closed configuration is achieved by placement of the key member 36 in the slot 38 and actuation of the clamping cylinder 30 to draw the two portions together around the component 4 in the region to be welded. This establishes a water-tight seal with the aid of split seals 20,20′, 22, 22′, and forms enclosure 40 around the area of the component to be welded. A slurry line 42 is provided which is connected at one end to a reservoir (not shown) of flux slurry, and at the other end to entrance port 44 in an upper surface of portion 12 of the enclosure tool to facilitate introduction of slurry into the enclosure 40 formed by the tool when clamped around the component 4. A water level detector sensor 46 is provided which senses the level of water in the enclosure 40 and enables the user to ascertain when water has been evacuated from the enclosure through exhaust line 48. Water may be evacuated from the enclosure through exhaust line 48 by displacement as a result of introduction of air into the enclosure 40 through pressure line 34, or by introduction of slurry through the slurry line 34 into the enclosure 40.

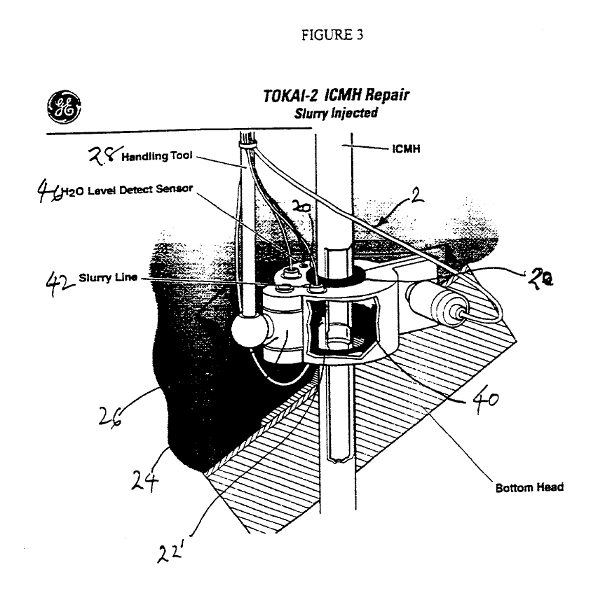

FIG. 3 shows the enclosure tool 2 with the enclosure 40 evacuated of water and full of flux slurry. Flux slurry is introduced through line 42 and the substantial absence of water in the enclosure 40 is detected by the water level detector sensor 46.

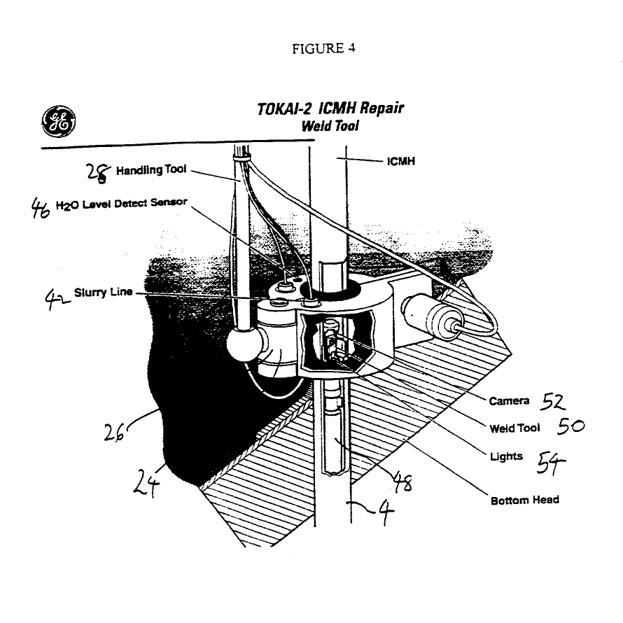

In FIG. 4, there is shown a welding tool assembly 48 located within the component 4 and provided with a welding head 50, camera 52 and lights 54. The welding tool assembly is introduced into the interior of the component 4 to a position adjacent the crack 10 to be welded. The camera 52 projects an image of the area to be welded to the user as a result of illumination of the area by the lights 54.

In use, the enclosure tool 2 is lowered into the water of the nuclear reactor and positioned adjacent the region of the component 4 to be welded. The portions 12,14 are in their open configuration, as shown in FIG. 1. The portions are closed around the region of the component containing the crack to be welded and the key member 36 is engaged in slot 38 (FIG. 1). The clamping cylinder is actuated to draw the key member 36 into the cylinder and clamp the tool around the component to form a water-tight seal. The water in the resulting enclosure 40 is substantially evacuated though exhaust line 48, either by air pressure introduced though pressure line 34 or by introduction of slurry directly into the enclosure through slurry line 42, to produce a substantially water-free environment. By “substantially water-free” is meant that the amount of any water remaining in the enclosure is sufficiently small to not interfere with the function of the flux slurry during the welding operation. Generally, at least 95% by weight of water initially present in the enclosure is evacuated, more usually greater than about 99% by weight.

Once introduction of slurry into the enclosure is completed, the welding tool assembly 48 is introduced into the interior of component 4 so that the welding tool is opposite the crack 10 to be welded. Positioning of the welding tool assembly 48 is facilitated by the light 54 and camera 52 which projects an image of the region to be welded to the user. Once correctly positioned, the welding tool is actuated and the crack is welded. When welding is completed, the tool assembly 48 is withdrawn from the component 4, and the tool 2 with the slurry (now in hardened form following welding) are removed from the reactor by actuation of the clamping cylinder 30 to permit the tool 2 to be opened and removed by the operator by manipulation of the handling tool 28.

The flux employed in the invention may be any suitable conventional flux. Typically, Solar Flux Type I is employed which is comprised of powdered metal mixed with a small amount of a liquid medium such as an alcohol, typically ethanol, to give a flux having a gel consistency. As noted above, during welding, the flux undergoes heating and hardens within the enclosure.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of welding, comprising surrounding a region in a metal component to be welded with a flux and welding said region.

2. A method according to claim 1, wherein said welding is carried out in a substantially water-free environment.

3. A method according to claim 1, wherein said region is surrounded by an water-tight enclosure which is filled with flux.

4. A method of welding underwater, comprising surrounding a region to be welded with a flux in a substantially water-free environment, and welding said region.

5. A method according to claim 4, wherein said region to be welded comprises a crack or opening.

6. A method according to claim 4, wherein said region to be welded is surrounded by a sealed enclosure and water is evacuated from said enclosure prior to introduction of flux into said enclosure.

7. A method according to claim 6, wherein a welding tool assembly is placed inside said component and welding is performed with said flux acting as a backing.

8. A method according to claim 7, wherein said welding tool assembly includes a welding head, a camera and a light.

9. A method according to claim 8, wherein said camera projects an image of said region to be welded to facilitate positioning of said welding head adjacent said area.

10. A method according to claim 6, wherein at least 95% by weight of water is evacuated from said enclosure.

11. A method according to claim 10, wherein greater than about 99% by weight water is evacuated from said enclosure.

12. A method of welding a component in a nuclear reactor, comprising surrounding a region to be welded with a flux in a substantially water-free environment, and welding said region.
